(19) United States
(12) Patent Application Publication
(10) Pub. No.: US 2011/0198395 A1
(43) Pub. Date: Aug. 18, 2011

(54) HANDHELD MOBILE CREDIT CARD READER

(76) Inventor: Mike CHEN, Arcadia, CA (US)

(21) Appl. No.: 12/706,449

(22) Filed: Feb. 16, 2010

(51) Int. Cl. G06K 7/00; G06Q 40/00

(52) U.S. Cl. 235/380

(57) ABSTRACT

A handheld mobile credit card reader includes a handy housing having a clamping space for holding a mobile electronic device, a card reader module mounted in a compartment in the housing and having a card slot set in alignment with a card-sliding slot at the front side of the housing for allowing a person to slide an electronic card therethrough and a card reader unit adapted for reading data from the electronic card being moved through the card slot, and a signal transmission device set in the front side of the housing for the connection of the attached mobile electronic device and electrically connected with the card reader unit for transmitting fetched data from the cad reader unit to the attached mobile electronic device for enabling the attached mobile electronic device to transmit the data to a remove remote credit card transaction processing center wirelessly to make a payment.

### BACKGROUND OF THE INVENTION

1. Field of the Invention

The present invention relates to credit card readers and more particularly, to a handheld card reader, which is practical for use with a mobile electronic device for conducting wireless electronic transactions at any time and at any place where the attached mobile electronic device is connectable to the remote credit card transaction processing center wirelessly. It is another object of the present invention to provide a handheld mobile credit card reader, which fits any of a variety of different sizes of mobile electronic devices.

2. Description of the Related Art

Following development of financial business and progress of transactions, plastic money has been intensively used to substitute for real money payment. By means of plastic money (credit card, cash card), consumers need not to carry a big amount of cash when going to buy things, avoiding loss of cash, pickpockets or cash-robbing, and preventing receiving counterfeit bills during a transaction. Nowadays, more and more people are willing to use plastic money in transactions. When making a credit card or cash card payment, the shop staff needs to connect a credit card reader to the remote credit card transaction processing center through a telephone line to obtain the authorization code and then to input the amount of money to be paid. Therefore, commercial credit card readers are commonly installed inside a house where a telephone line is available for connection to the remote credit card transaction processing center.

In a shop, department store or sales center, a credit card reader is provided at every payment counter or checkout counter. When a consumer parched the desired items, the salesman or saleswomen may have to carry the consumer's credit card to the payment counter or checkout counter and swipe the credit card and to make the payment. During peak hours, salesmen or saleswomen may have to line up in the payment counter or checkout counter, wasting much time. When a salesman or saleswoman leaved from his or her sales counter, the sales counter is unguarded. Further, the credit card reader may be interrupted due to a long use, causing transaction trouble.

As stated above, the use of conventional credit card readers has numerous drawbacks as follows:

1. A conventional credit card reader must be installed in a house for connection to the remote credit card transaction processing center through a telephone line for the swiping of a credit card or cash card. Because of low mobility, conventional credit card readers are not convenient in use.

2. During peak hours, the people may have to line up in the payment counter or checkout counter, wasting much time in making the payment.

3. In a big-scale shop, sales center or department store, credit card readers are provided at payment counters or checkout counters, a salesman or saleswomen must go away from the sales counter and carry the consumer's credit card to a nearby payment counter or checkout counter and to swipe the credit card and to make the payment, leaving the sales counter unguarded.

Therefore, it is desirable to provide a mobile handheld card reader, which eliminates the aforesaid problems and

### SUMMARY OF THE INVENTION

The present invention has been accomplished under the circumstances in view. It is therefore the main object of the present invention to provide a handheld mobile credit card reader, which is practical for use with a mobile electronic device for conducting wireless electronic transactions at any time and at any place where the attached mobile electronic device is connectable to the remote credit card transaction processing center wirelessly. It is another object of the present invention to provide a handheld mobile credit card reader, which fits any of a variety of different sizes of mobile electronic devices.

To achieve these and other objects of the present invention, a handheld mobile credit card reader comprises housing, a card reader module and a signal transmission device. The housing comprises an accommodation chamber, a compartment disposed at one lateral side relative to the accommodation chamber, a card-sliding slot disposed at the front side thereof in communication with the compartment, a clamping space defined in the front side at one lateral side relative to the card-sliding slot and a plurality of supporting rods suspending in the lower part in the front side. The card reader module is mounted in the compartment, comprising a card slot set in the card-sliding slot of the housing for allowing a person to slide an electronic card therethrough and a card reader unit adapted for reading data from the electronic card being moved through the card slot. The signal transmission device is set in between the supporting rods of the housing, comprising a connection interface for the connection of an internal transmission interface of the mobile electronic device that is attached to the clamping space of the housing and a signal transmission line electrically connected to the card reader unit for transmitting fetched data from the card reader unit to the attached mobile electronic device for enabling the attached mobile electronic device to transmit the data to a remove remote credit card transaction processing center wirelessly.

Further, a clamping plate is coupled to the accommodation chamber of the housing and movable relative to the housing to adjust the width of the clamping space subject to the side of the attached mobile electronic device.

### BRIEF DESCRIPTION OF THE DRAWINGS

FIG. 1 is an elevational view of a handheld mobile credit card reader in accordance with the present invention.

FIG. 2 is an exploded view of the handheld mobile credit card reader in accordance with the present invention.

FIG. 3 is another exploded view of the handheld mobile credit card reader in accordance with the present invention when viewed from another angle.

FIG. 4 is a schematic front view of the handheld mobile credit card reader in accordance with the present invention, showing the clamping plate adjusted relative to the base frame.

FIG. 5 is a schematic front view of the present invention, showing a status of use of the handheld mobile credit card reader.

### DETAILED DESCRIPTION OF THE PREFERRED EMBODIMENT

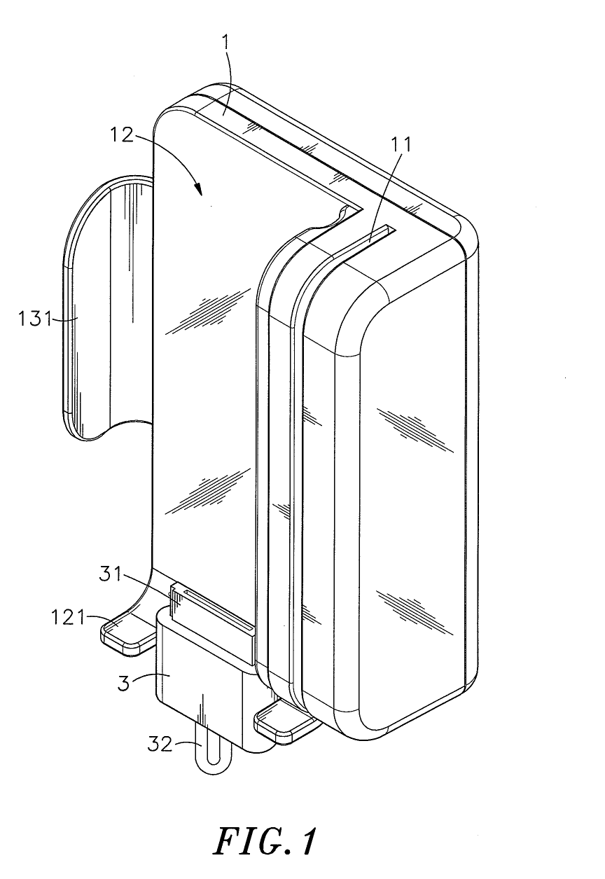

Referring to FIGS. 1˜3, a handheld mobile credit card reader in accordance with the present invention is shown comprising a housing 1, a card reader module 2 and a signal transmission device 3.

The housing 1 comprises a base frame 12, which has a compartment 100 disposed at one lateral side thereof, a card-sliding slot 11 located on the front side in communication with the compartment 100, a plurality of, for example, two supporting rods 121 bilaterally suspending in the bottom side and a plurality of mounting screw holes 163 disposed at the back side thereof and spaced around the border area, a back cover shell 16, which has a plurality of mounting through holes 162 respectively connected to the mounting screw holes 163 of the base frame 12 with screws 161 and defines with the backside of the base frame 12 an accommodation chamber 10, a track unit 14 transversely disposed in the accommodation chamber 10 and a sliding clamping plate 13 disposed at one lateral side of the base frame 12 opposite to the card-sliding slot 11 and movable in and out of the track unit 14. The track unit 14 comprises a channel-like shell 15 that has a plurality of mounting through holes 152 respectively connected to respective mounting screw holes 153 at the backside of the base frame 12 with screws 151, two transverse rails 141 transversely located on the back side of the base frame 12 in parallel and two transverse grooves 142 located on the channel-like shell 15 and respectively coupled to the transverse rails 141. The sliding clamping plate 13 has a clamping portion 131 disposed at one end thereof and protruding over one lateral side of the base frame 12 remote from the card-sliding slot 11, a sliding rail portion 132 inserted into the inside of the track unit 14 and a stop block 133 located on the distal end of the sliding rail portion 132.

The card reader module 2 has a card slot 21 extending through the top and bottom sides thereof, a card reader unit 22 disposed at one lateral side of the card slot 21 and adapted for reading data from a credit card that is moved through the card slot 21, and a side cover 23 that covers the card reader unit 22 for protection.

The signal transmission device 3 has a connection interface 31 and a signal line 32 for signal transmission.

During installation, the card reader module 2 is mounted in the compartment 100 of the base frame 12 to keep the card slot 21 in alignment with the card-sliding slot 11 of the base frame 12, and then the signal transmission device 3 is set in between the two supporting rods 121 to hold the connection interface 31 in front of the base frame 12 for allowing the signal line 32 that is electrically connected to the card reader unit 22 of the card reader module 2 to be extended out of the housing 1.

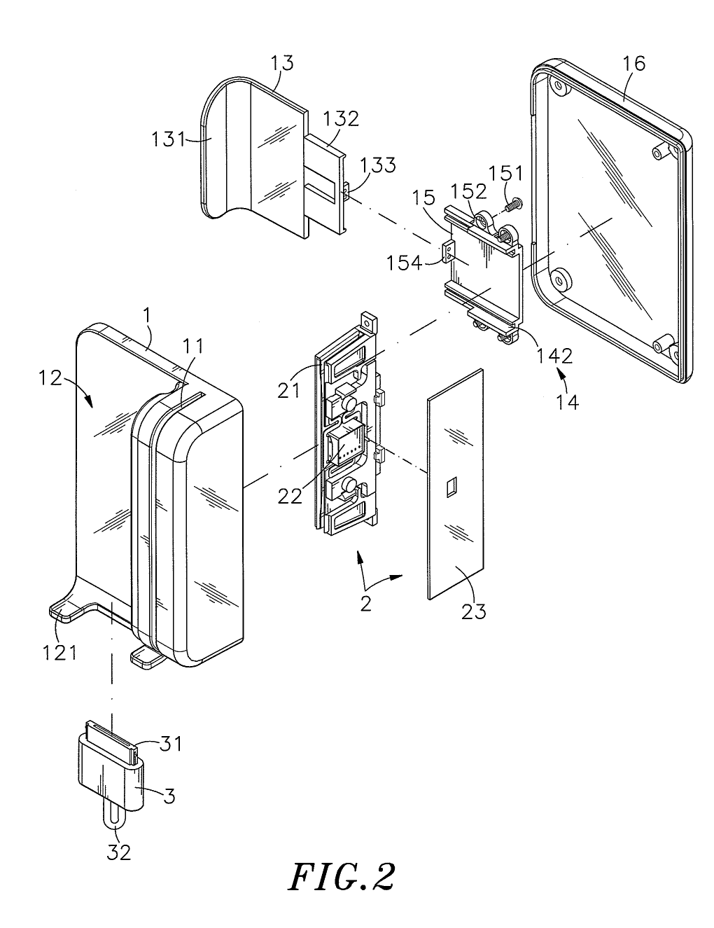

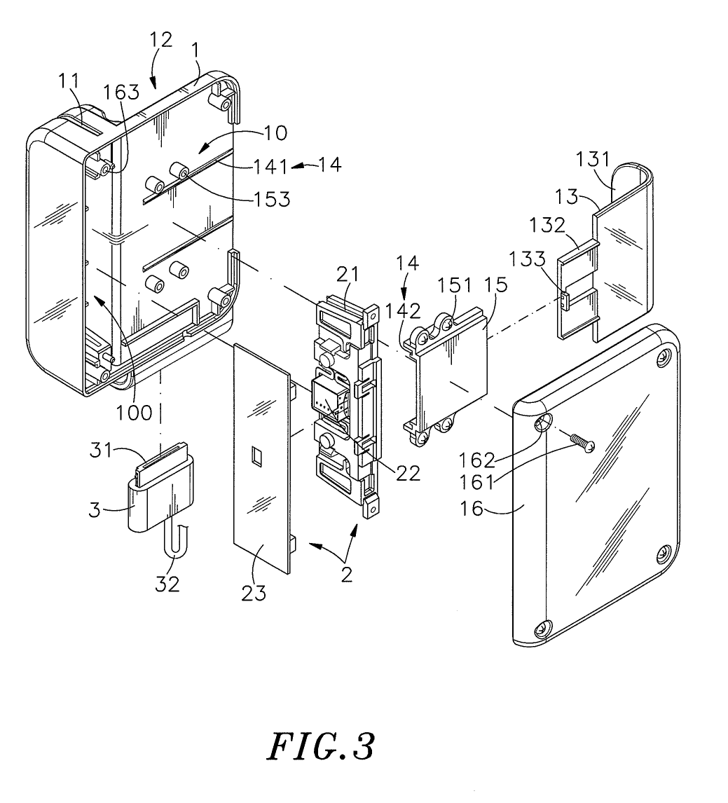

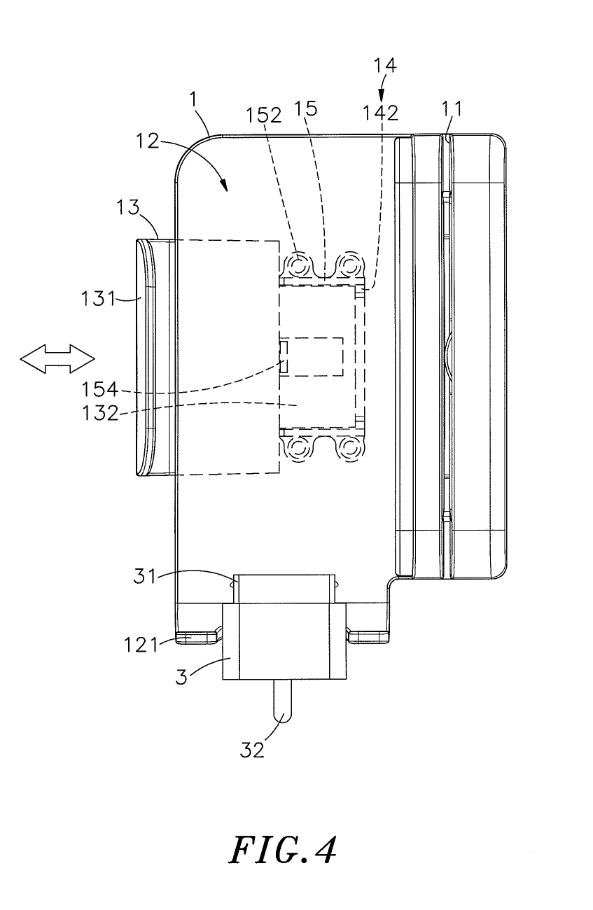

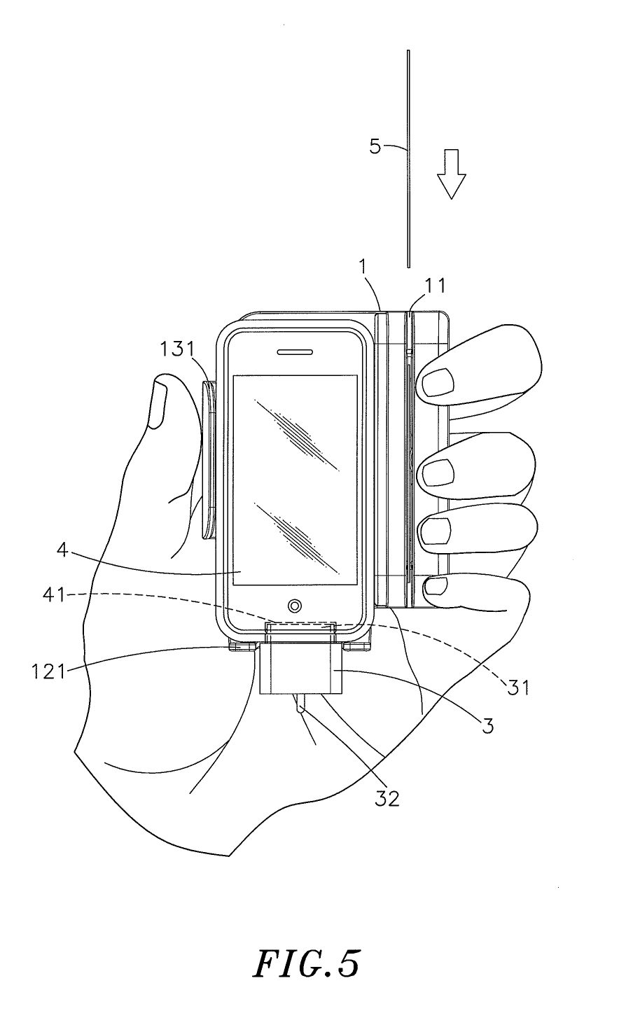

Referring to FIGS. 4 and 5 and FIGS. 2 and 3 again, during application of the handheld mobile credit card reader, a mobile electronic device (for example, a cell phone) 4 is inserted into the front side of the base frame 12 of the housing 1 and supported on the two supporting rods 121 to force its internal transmission interface 41 into connection with the connection interface 31 of the signal transmission device 3, and then the sliding clamping plate 13 is moved inwards toward the inside of the track unit 14 to clamp the clamping portion 131 on one lateral side of the mobile electronic device 4 against the periphery of the card-sliding slot 11. When the user slides an electronic card (for example, a credit card) through the card slot 21 of the card reader module 2 in the card-sliding slot 11 of the base frame 12, the card reader unit 22 of the card reader module 2 reads in storage data from the electronic card 5 and transmits fetched data to the signal transmission device 3, enabling the signal transmission device 3 to transmit the data to the internal transmission interface 41 of the mobile electronic device 4 through the connection interface 31 so that the mobile electronic device 4 can transmit the data to the remote credit card transaction processing center wirelessly to make a transaction.

By means of the mobile telephone operation mode of the mobile electronic device 4 to communicate with the remote credit card transaction processing center wirelessly, a user can use an electronic card 5 to make a transaction conveniently at anytime and at any place where the mobile electronic device 4 is connectable to the remote credit card transaction processing center wirelessly. Thus, the invention facilitates credit card transactions.

Further, the user can move the sliding clamping plate 13 in and out of the track unit 14 to adjust the width of the clamping space defined in front of the base frame 12 between the clamping portion 131 and one lateral side of the card-sliding slot 11 of the base frame 12 subject to the width of the mobile electronic device 4 used. The mobile electronic device 4 can be, for example, i phone, PDA, cell phone, or any of a variety of other small wireless electronic devices that can be supported on the supporting rods 121 and clamped on the base frame 12 by the sliding clamping plate 13. Further, the connection interface 31 of the signal transmission device 3 and the internal transmission interface 41 of the mobile electronic device 4 can be selected from the group consisting of USB, Mini-USB, eSATA and SATA connectors.

Further, the electronic card 5 can be a magnetic stripe type credit card, cash card, plastic money credit card or any of a variety of value-added electronic cards.

The handheld mobile credit card reader of the present invention enables the user to hold the housing 1 by hand conveniently. By means of setting the card slot 21 of the card reader module 2 in the card-sliding slot 11 of the base frame 12, the user can slide an electronic card 5 through the card slot 21 conveniently. When an electronic card 5 is moved through the card slot 21, the card reader unit 22 of the card reader module 2 reads in storage data from the electronic card 5 and transmits fetched data to the signal transmission device 3, enabling the signal transmission device 3 to transmit the data to the internal transmission interface 41 of the mobile electronic device 4 through the connection interface 31 so that the mobile electronic device 4 can transmit the data to a remote credit card transaction processing center wirelessly to make a transaction. Thus, the user needs not to line up in front of the checkout counter and can conduct electronic transactions at any place where the mobile electronic device 4 is connectable to the remote credit card transaction processing center wirelessly.

Further, the handheld mobile credit card reader can be used with a mobile electronic device 4 by a salesman or saleswoman in every sales counter in a sales center or department store. When a consumer purchased the desired items, the salesman or saleswoman at the sales counter can use the prepared handheld mobile credit card reader with a mobile electronic device 4 attached thereto for allowing the consumer to slide his (her) electronic card 5 through the card slot 21 of the card reader module 2 directly so that the card reader unit 22 of the card reader module 2 can read in storage data from the electronic card 5 and transmit fetched data to the remote credit card transaction processing center through the signal transmission device 3 and the attached mobile electronic device 4 for making the payment. Thus, the transaction can be completed conveniently within a short time.

As stated above, the invention provides a handheld mobile credit card reader, which comprises a housing 1 having a base frame 12 with supporting rods 121 and a clamping plate 13 for holding a mobile electronic device 4, a signal transmission device 3, which is mounted at the front side of the base frame 12 of the housing 1 and has a connection interface 31 for the connection of the attached mobile electronic device 4, and a card reader module 2, which is mounted in the housing 1 and which has a card slot 21 set in a card-sliding slot 11 of a base frame 12 of the housing 1 and a card reader unit 22 connected to a signal line 32 of the signal transmission device 3. The user can slide an electronic card 5 through the card slot 21 so that the card reader unit 22 can read data from the electronic card 5 and transmits fetched data to the remote credit card transaction processing center through the signal transmission device 3 and the attached mobile electronic device 4 for making the payment. By means of the application of the handheld mobile credit card reader, wireless electronic transactions can be conducted conveniently at any time and any place where the mobile electronic device 4 is connectable to the remote credit card transaction processing center wirelessly.

In conclusion, the invention provides a handheld mobile credit card reader, which has the following advantages and features:

1. By means of the arrangement of the housing 1, the card reader module 2 and the signal transmission device 3, the handheld mobile credit card reader can be used with a mobile electronic device 4 for enabling a user to swipe an electronic card 5 and to conduct wireless electronic transactions at any time and any place where the mobile electronic device 4 is connectable to the remote credit card transaction processing center wirelessly.

2. The arrangement of the base frame 12 with supporting rods 121 and the clamping plate 13 enables the user to attach a mobile electronic device 4 to the base frame of the housing 1 and to connect the attached mobile electronic device 4 to the signal transmission device 3 positively so that the handheld mobile credit card reader can be used with the mobile electronic device 4 to conduct wireless electronic transactions conveniently at any time and any place where the mobile electronic device 4 is connectable to the remote credit card transaction processing center wirelessly, facilitating on-line shopping and payment.

3. A salesman or saleswoman in every sales counter in a sales center or department store can use the handheld mobile credit card reader for allowing a consumer to make a credit card payment directly after purchase, saving much the transaction time.

Although a particular embodiment of the invention has been described in detail for purposes of illustration, various modifications and enhancements may be made without departing from the spirit and scope of the invention. Accordingly, the invention is not to be limited except as by the appended claims.

1. A handheld mobile credit card reader for use with a mobile electronic device for the swiping of a mobile electronic card to conduct wireless electronic transactions, the handheld mobile credit card reader comprising:
a housing, said housing comprising an accommodation chamber, a compartment disposed at one lateral side relative to said accommodation chamber, a card-sliding slot disposed at a front side thereof in communication with said compartment, a clamping space defined in said front side at one lateral side relative to said card-sliding slot and a plurality of supporting rods suspending in a lower part in said front side;
a card reader module mounted in said compartment, said card reader module comprising a card slot set in said card-sliding slot of said housing for allowing a person to slide an electronic card therethrough and a card reader unit adapted for reading data from the electronic card being moved through said card slot; and
a signal transmission device set in between said supporting rods of said housing, said signal transmission device comprising a connection interface for the connection of an internal transmission interface of the mobile electronic device that is attached to said clamping space of said housing and a signal transmission line electrically connected to said card reader unit for transmitting fetched data from said card reader unit to the attached mobile electronic device for enabling the attached mobile electronic device to transmit the data to a remove remote credit card transaction processing center wirelessly;
said housing further comprising a base frame defining therein said compartment, said card-sliding slot and said clamping space, a track unit mounted in a back side of said base frame, said track unit comprising a channel-like shell affixed to the back side of said base frame, two transverse rails transversely located on the back side of said base frame in parallel and two transverse grooves located on said channel-like shell and respectively coupled to said transverse rails, and a sliding clamping plate, said sliding clamping plate having a clamping portion disposed at one end thereof and protruding over one lateral side of said base frame remote from said card-sliding slot and movable to adjust the width of said clamping space, a sliding rail portion disposed at an opposite end thereof and inserted into the inside of said track unit and movable with said clamping portion between said two transverse rails and a back cover shell covered on the back side of said base frame; said accommodation chamber is defined between said base frame and said back cover shell.

2. (canceled)

3. (canceled)

4. The handheld mobile credit card reader as claimed in claim 1, wherein said card slot of said card reader module is configured for enabling a user to slide therethrough an electronic card that is a magnetic stripe credit card or cash card.

5. The handheld mobile credit card reader as claimed in claim 1, wherein said connection interface of said signal transmission device is compatible to the internal transmission interface of the attached mobile electronic device and selected from a group consisting of USB (Universal Serial Bus), Mini-USB (Mini Universal Serial Bus), SATA (Serial Advanced Technology Attachment) and eSATA (External Serial Advanced Technology Attachment) connectors.

6. The handheld mobile credit card reader as claimed in claim 1, wherein the attached mobile electronic device is a PDA (personal data assistant) or cellular telephone.
